(19) United States
(12) Patent Application Publication
(10) Pub. No.: US 2026/0027743 A1
(43) Pub. Date: Jan. 29, 2026

(54) CUTTING APPARATUS FOR CUTTING SEGMENTS FOR ENERGY CELLS FROM A FED CONTINUOUS WEB

(71) Applicant: KÖRBER TECHNOLOGIES GMBH, HAMBURG (DE)

(72) Inventors: Nils KLAPER, DRAGE (DE); Karsten ECKERT, TREMSBÜTTEL (DE); Frank GROTHAUS, PAPENBURG (DE)

(21) Appl. No.: 18/997,736

(22) PCT Filed: Jul. 25, 2023
(86) PCT No.: PCT/EP2023/070598

§ 371 Date: Jan. 22, 2025

(30) Foreign Application Priority Data
Jul. 27, 2022 (DE) 10 2022 118 808.6

(51) Int. Cl. B26D 1/40; B26D 1/62; B26D 5/00; B26D 5/02; B26D 7/24

(52) U.S. Cl. CPC B26D 1/405; B26D 1/626; B26D 5/007; B26D 5/02; B26D 7/24

(57) ABSTRACT

The invention relates to a cutting apparatus for cutting segments for energy cells from a continuous web fed into a gap in a cutting plane, comprising-a rotating cutting device which is driven by means of a first drive device in a rotary movement about an axis of rotation, is arranged on one side of the gap and has at least one cutting blade protruding radially outwards from a boundary surface of the rotating cutting device, in particular a cutting drum having at least one cutting blade protruding radially outwards from a jacket surface of the cutting drum, wherein—the cutting edge of the cutting blade slides in punctiform contact on the cutting edge of the counter-blade during the rotary movement of the rotating cutting device, in particular the cutting drum, during the cutting of the continuous web, and—the first drive device is torque-controlled at least during the sliding of the cutting edge of the cutting blade on the cutting edge of the counter-blade.

The present invention relates to a cutting apparatus for cutting segments for energy cells from a fed continuous web having the features of the preamble of claim 1.

Energy cells or energy storage devices within the meaning of the invention are used, for example, in motor vehicles, other land vehicles, ships, aircraft or also in stationary systems such as photovoltaic systems, in the form of battery cells or fuel cells in which very large amounts of energy have to be stored over longer periods of time. For this purpose, such energy cells have a structure consisting of a plurality of segments stacked to form a stack. These segments are each formed from alternating anode sheets and cathode sheets, which are separated from one another by separator sheets that are also produced as segments. The segments are pre-cut in the production process and then placed on top of each other in the predetermined sequence to form the stacks and joined together by lamination. The anode sheets and cathode sheets are first cut from a continuous web and then placed individually at intervals on a continuous web of separator material. This subsequently formed “two-ply” continuous web made of the separator material with the anode sheets or cathode sheets placed on top is then cut into segments again in a second step by means of a cutting apparatus, wherein the segments in this case are each formed in a double layer by a separator sheet with an anode sheet or cathode sheet arranged on top. If this is technically feasible or necessary from a manufacturing perspective, the continuous webs of separator material with the anode sheets and cathode sheets placed on top of each other can also be placed on top of each other before cutting, so that a continuous web is formed with a first endless layer of separator material with anode sheets or cathode sheets placed thereon and a second endless layer of separator material with anode sheets or cathode sheets placed thereon. This “four-ply” continuous web is then cut into segments by means of a cutting apparatus, which segments are in this case formed in four layers with a first separator sheet, an anode sheet, a second separator sheet and a cathode sheet lying thereon. The advantage of this solution is that one cut can be saved. Furthermore, another continuous web of a separator material can be placed on the prefabricated “two-ply” continuous web with the continuous web of separator material and the electrodes resting thereon, so that a “three-ply” continuous web is formed, from which three-ply segments are then cut accordingly. “Segments” within the meaning of this invention are therefore single-ply segments of a separator material, anode material or cathode material, double-ply, triple-ply or four-ply segments of the structure described above.

The production of battery cells, for example for electromobility, takes place nowadays in production lines with an output of 100 to 240 monocells per minute. These operate in sub-regions or continuously with clocked discontinuous movements, such as back-and-forth movements, and are therefore limited in terms of production output. The majority of known machines operate using the single-sheet stacking method (e.g. “pick and place”) with the disadvantage of slower processing. Laminating cell formations is not possible here.

Another well-known approach involves a machine having continuously running material webs and clocked tools, such as cutting blades and tools for adjusting divisions.

In principle, machines with clocked movements are limited in terms of performance. The parts with mass, such as receptacles and tools, must be constantly accelerated and decelerated. The processes determine the timing, and a great deal of energy is consumed. The mass of the moving parts cannot be reduced arbitrarily. Faster moving parts often have to endure higher loads and therefore become more complex and heavier.

In order to reduce the production costs of battery manufacturing, the production speed of the machines must be increased, among other things. A prerequisite for high production output is a high production rate of the stacks of energy cells, which are formed from a plurality of segments of the type described above and which are stacked on top of each other.

In order to achieve very high production rates, it is desirable to continuously feed the continuous webs made of the material of the segments and then to cut the segments from these continuously fed continuous webs by means of a cutting apparatus in the running process. This is particularly the case with the anode sheets and cathode sheets, which are cut and then placed at intervals on a continuous web of separator material.

Such a device for producing energy cells with a cutting apparatus is known, for example, from DE 10 2017 216 213 A1. The cutting apparatus is implemented here in the form of a laser cutting apparatus, which has a laser directed onto the circumference of a drum, which laser cuts the segments from a continuous web guided on the drum. The disadvantage of this cutting apparatus is that the cutting process requires very precise control of the laser. If the laser beam cannot be directed directly onto the continuous web to be cut, it is deflected by a scanner which is stationary relative to the continuous web (remote laser cutting). The scanner includes, among other things, mirrors and associated motors, which, due to their limited dynamics, put limits on the speed of the cutting process.

From document U.S. Pat. No. 6,585,846 B1, a device is also known in which the segments are cut from a continuous web by means of a cutting drum driven in rotary movement and having one or more cutting blades and a counter-drum having one or more counter-blades. The cutting drum and the counter-drum are driven in opposite directions of rotation at identical rotational speeds, so that in the oppositely situated portions of the jacket surfaces they have a circumferential speed which is identical and directed in the same direction in relation to the movement of the fed continuous web. The cutting edges of the cutting blades and the counter-blades are arranged parallel to the axes of rotation of the cutting drum and the counter-drum and perpendicular to the circumferential movements and cause a vertical line cut through the continuous web running between the cutting drum and the counter-drum for cutting the segments.

The disadvantage of this solution, however, is that the rotary movements of the cutting drum and the counter-drum must be coordinated very precisely and that speed differences in particular must be avoided in any case, because otherwise a clean cut through the continuous web cannot be achieved. Furthermore, the cutting edges of the cutting blades and the counter-blades cut through the continuous web simultaneously over their entire length, which requires correspondingly high cutting forces. This limits the cutting width which can be achieved and results in increased wear of the cutting edges combined with a deterioration in cutting quality.

Furthermore, an apparatus is known from WO 2019/092 585 A2 which has two cutting drums driven in oppositely directed rotary movements, each having a cutting blade. The cutting drums are arranged in such a way that the cutting circles of the cutting edges defined by the cutting blades do not overlap, wherein the spacing of the cutting circles should be 1 to 10 μm. The drive rotary movements of the two cutting drums are coordinated in such a way that the cutting blades cut through the continuous web with their cutting edges simultaneously but at a predetermined distance of 1 to 10 μm from each other. Here, too, the cutting edges of the cutting blades are aligned parallel to the axes of rotation of the cutting drums and thus also parallel to each other, so that the cutting edges each cut through the continuous web in a linear cut across the entire width.

The disadvantage of this solution is that the rotary movements of the cutting drums must be coordinated to one another very precisely so that the two cutting edges cut through the continuous web in a defined alignment to each other to achieve a clean cut. In addition to the disadvantages described above of high cutting forces, limited cutting width, increased wear and reduced cutting quality, this apparatus also requires very precise positioning of the cutting drums and the cutting edges rotating around them in relation to the counter-drum so that the required distance is not fallen short of, as otherwise the cutting edges could collide. Furthermore, the distance between the cutting circles of the cutting edges of the cutting drum and the counter-drum must not be greater than the specified distance of 1 to 10 μm, because otherwise a clean cut cannot be achieved because the cutting edges form the abutment against each other required for the cut.

Against this background, the invention is based on the object of providing a cutting apparatus which allows clean, process-reliable cutting of segments for energy cells from a continuous web while at the same time maintaining a high transport speed of the supplied continuous web.

According to the basic idea of the invention, it is proposed that the cutting edge of the cutting blade slides in punctiform contact on the cutting edge of the counter-blade during the rotary movement of the rotating cutting device, in particular of the cutting drum, during the cutting of the continuous web, and the first drive device is torque-controlled at least during the sliding of the cutting edge of the cutting blade on the cutting edge of the counter-blade.

The torque exerted by the first drive device on the rotating cutting device, in particular on the cutting drum, is the cause of the cutting edge contact pressure force exerted by the cutting blade on the counter-blade. Thus, the proposed torque control of the first drive device allows regulation of the cutting edge contact pressure force according to a predetermined curve or a predetermined value during the cutting process. The cutting edge contact force results directly from the drive torque of the first drive device, taking into account the laws of mechanics, and can therefore be calculated from it.

The drive torque of the first drive device can preferably be controlled or regulated, or can be controllable or regulable, depending on the position of the cutting blade in relation to the counter-blade, whereby, for example, an individual contour of the cutting edge of the cutting blade or of the counter-blade can be taken into account, for example to achieve an optimized cutting process or to compensate for a change in the contour of the cutting edge(s) due to wear. Furthermore, the position of the cutting blade in relation to the counter-blade is a clear criterion by which the cutting process can be distinguished from the intermediate positions of the cutting blade and the counter-blade in which they do not touch each other. The position of the cutting blade relative to the counter-blade depends on the angle of rotation of the rotating cutting device in relation to the angle of rotation of the counter-blade, which in turn depends on the angular rotational speed of the rotating cutting device relative to the counter-blade. In this case, the regulation or control of the drive torque of the first drive device is used to change the angular rotational speed of the rotating cutting device between the cutting processes, whereby in turn the position and alignment of the relevant cutting blade in relation to the counter-blade in the subsequent cutting process are controlled or regulated. For this purpose, the angular rotational position of the rotating cutting device can be detected by means of a rotation angle sensor, whereby the control can be extended to include regulating the position of the cutting blades in order to maintain a predetermined position of the cutting blade in relation to the counter-blade.

It is further proposed that the position of the cutting blade is controlled or is controllable by means of the first drive device depending on a position of a predetermined first contact point of the counter-blade. The specified first contact point is individually calibrated before the cutting apparatus is put into operation and must be hit precisely on the relevant counter-blade during each cutting process when the cutting apparatus is operated in order to achieve a clean cut by regulating the position of the cutting blade so that at the start of the cutting process its cutting edge comes into contact with the cutting edge of the counter-blade exactly at the specified first contact point. For this purpose, the position control, made possible by the first drive device, of the cutting blades or of the entire rotating cutting device, in particular of the cutting drum, is provided, which moves the cutting blades into the predetermined alignment and/or rotation angle position in the phase of the rotary movement before each cutting process so that they come into punctiform contact with the cutting edge of the counter-blade at the predetermined first contact point. In this phase, the regulation or control of the drive torque of the rotating cutting device corresponds to position regulation or control of the rotating cutting device and the cutting blades by changing the angle of rotation.

It is further proposed that the drive torque of the first drive device is regulated or controlled or can be regulated or controlled such that a maximum value of an overpressure of the cutting blade relative to the counter-blade is not exceeded during the cutting. On the one hand, the overpressure of the cutting edges is unavoidable to a certain extent when the cutting pressure is applied and is even desirable in order to ensure that the cutting edges are permanently in contact with each other in order to achieve a clean cut. However, if the overpressure becomes too high, it is the main cause of damage to the cutting edges, up to and including breakage of the cutting blade and the counter-blade. Thus, the proposed regulation system can, on the one hand, achieve a clean cut by ensuring that the cutting edge of the cutting blade always rests against the corresponding cutting edge of the counter-blade with a certain overpressure during the cutting process, and, on the other hand, the probability of damage to the cutting edges can be reduced at the same time by controlling the movement of the cutting edge of the cutting blade in such a way that the overpressure is limited to a maximum value. On the one hand, the overpressure can be determined via a sensor on the cutting blade, which generates a signal representing the deformation of the cutting blade. Alternatively, the overpressure can also be determined indirectly from the effective drive torque of the first drive device, taking into account the spring stiffness of the cutting blade, the counter-blade, and the other parts in the power transmission path.

It is further proposed that the drive torque of the first drive device is regulated as a function of a predetermined cutting edge contact pressure force to be exerted by the cutting blades on the counter-blades. The specified cutting edge contact pressure force can preferably be constant and/or adapted to the continuous web to be cut. The predetermined cutting edge contact pressure force can preferably be preset and selected at different strengths depending on the material properties of the segments to be cut. The cutting edge contact pressure force results from the drive torque of the first drive device and can be determined directly by a corresponding pressure sensor or indirectly from the drive torque of the first drive device by calculating it therefrom. The cutting pressure force can be regulated or controlled by increasing or decreasing the drive torque, wherein the position of the angle of rotation of the cutting blade relative to the counter-blade can also be changed.

The cutting edge contact pressure force can preferably be between 5 and 100 N. If, for example, separator sheets are to be cut from a thin continuous web having a thickness of 10 to 20 μm of a tough separator material, a cutting pressure force of 10 to 20 N is sufficient. If segments in the form of thicker anode sheets or cathode sheets are to be cut from a continuous web, a cutting pressure force of 20 to 40 N is sufficient. If four-ply monocells or pre-products made of two separator sheets having an electrode arranged therebetween having a correspondingly higher thickness and rigidity are to be cut, a cutting pressure force of 30 to 100 N can be set.

It is further proposed that at least two counter-blades are provided, and the drive torque of the first drive device is regulated or controlled or is regulable or controllable individually for each counter-blade depending on the position of the cutting blade in relation to the counter-blade which subsequently comes into punctiform contact therewith, and/or depending on the predetermined first contact point of the counter-blade which subsequently comes into contact therewith. The counter-blades are individually clamped in the counter-drum and/or manufactured by an individual machining process, so that the counter-blades and their cutting edges have an individually different alignment, arrangement, and/or shape due to unavoidable manufacturing inaccuracies. This different alignment, arrangement, and/or shape can be compensated by a counter-blade-specific regulation of the first drive device during the cutting process, to such an extent that its influence on the quality of the cutting process is reduced. Furthermore, the drive torque of the first drive device and the position of the cutting blades are controlled or regulated individually for each counter-blade in such a way that the cutting blade always comes to rest exactly at the first contact point of the corresponding counter-blade, which contact point was previously measured individually for each counter-blade, at the beginning of the cutting process.

It is further proposed that a storage device is provided with a data set which represents a curve of the drive torque and/or the position of the first contact points of the counter-blades which is individualized with respect to the cutting movement of the cutting blade(s) on the counter-blade(s), and the drive torque of the first drive device is or can be regulated according to the data set. The data set can be created, for example, in a calibration process for the counter-blades individually for all counter-blades of a counter-drum, wherein in the calibration process both the first contact points and curves optimized for each cutting edge of the drive torque of the first drive device are determined and saved, which can depend for example on the geometry and alignment of the cutting edges of the counter-blades. This data set having the drive torques and first contact points individualized for the counter-blades is then used in the operation of the cutting apparatus to control and/or regulate the first drive device.

It is further proposed that a warning device is provided which emits or displays a warning signal depending on an exceeding of predetermined tolerances of the alignment of the cutting blade(s) in relation to the counter-blade(s) and/or in the event of an incorrect alignment of a counter-blade(s) and/or in the event of an exceeding of predetermined tolerances of the shape of the cutting blade(s) or the counter-blade(s). Such an incorrect alignment of the cutting blades and/or the counter-blades can for example lead to a collision between the cutting blade and the counter-blade and thus to breakage of one of the two blades. Furthermore, abrading caused by wear of the cutting edges and the resulting change in shape can lead to a worsened cut of the segments which no longer meets the specified quality requirements. Both these states are brought to the operator's attention by a warning signal, so that the operator can check the cutting apparatus. For this purpose, the cutting apparatus can be stopped briefly, and the operator can then replace or realign the cutting blades and the counter-blades individually or as a whole.

It is further proposed that a pivoting device or displacement device is provided with which the cutting drum can be pivoted or displaced from a cutting position into a passive position at a distance from the counter-blade(s). In the passive position, the cutting edge of the cutting blade no longer comes into contact with the cutting edge of the counter-blade, and the cutting process is thus practically interrupted. This passive position of the cutting drum can be used for example to test the functionality of the cutting drum and/or the counter-drum without a cutting process being carried out and/or the cutting edges coming into contact with one another. Furthermore, the pivoting device or displacement device can also be activated by the operator or automatically after an activation of the warning device, so that the cutting process of the cutting apparatus is interrupted and the maintenance and/or inspection operations can be carried out.

It is further proposed that a counter-rotation body, in particular a counter-drum, is provided, and the counter-blade(s) is or are formed by one or more cutting edges arranged on the counter-rotation body, in particular on the counter-drum. The cutting edges can, for example, be incorporated into the jacket surface of the counter-drum or can also be provided on separate insert parts which are inserted into corresponding receptacles in the counter-drum.

It is further proposed that a second drive device is provided which drives the counter-rotation body, in particular the counter-drum, in rotary movement about an axis of rotation, wherein the axis of rotation of the counter-rotation body, in particular the counter-drum, is aligned parallel to the axis of rotation of the rotating cutting device, in particular the cutting drum, and the direction of rotation of the rotary movement of the counter-rotation body, in particular the counter-drum, is aligned opposite to the direction of rotation of the rotating cutting device, in particular the cutting drum. Due to the provided counter-rotation body driven in rotary movement, in particular by the counter-drum with the counter-blade(s) arranged thereon, the cutting apparatus can be integrated into a drum operation with a very high cutting frequency and production capacity of the segments. Furthermore, the fed continuous webs can be transported in a drum operation, cut immediately and, after cutting, transported further in the drum operation and processed.

It is further proposed that the first and/or second drive device of the rotating cutting device, in particular of the cutting drum and/or of the counter-rotation body, in particular of the counter-drum, is formed by a servomotor. Servomotors have the advantage of having very precise and fast regulation, wherein the regulation of the drive devices can be very easily coupled together in a corresponding control program. The servomotors are controlled by controlling the active current and thereby changing the drive torque exerted on the rotating cutting device and/or the counter-rotation body in order to implement the described control and regulation.

It is further proposed that the moment of inertia of the rotating cutting device, in particular of the cutting drum, is preferably smaller by at least a factor of 100 than the moment of inertia of the counter-rotation body, in particular of the counter-drum. The counter-rotation body, in particular the counter-drum, serves to transport the continuous web until the segments are cut and to transport the segments away from the continuous web after cutting. In order to achieve a high production capacity, it is designed with a comparatively large outer diameter and is driven at a constant rotational speed. In contrast, the rotating cutting device, in particular the cutting drum, carries the cutting blade(s) and is used solely for cutting the segments. The rotating cutting device has a much smaller diameter than the counter-drum and is driven at a considerably higher speed than the counter-rotation body. In order for the cutting blade(s) arranged thereon to be moved as quickly and precisely as possible into the above-described predetermined position of the first contact point and the alignment with the counter-blade(s) at the predetermined overpressure, and while exerting the predetermined cutting pressure force on the counter-blade, it has the correspondingly lower moment of inertia. Furthermore, the required drive torque of the cutting drum, and thus the exerted cutting pressure force, can be regulated and controlled much more precisely.

Furthermore, a method for controlling a cutting apparatus according to one of claims 11 to 14 is proposed, in which a data set of a curve of the first drive torque and/or the first contact point(s) of the counter-blade(s) related to the angle of rotation of the counter-rotation body, in particular the counter-drum, is generated in a calibration process, and the first drive device is regulated according to the data set determined in the calibration process. In the proposed method, the cutting apparatus is calibrated in a calibration process before being put into operation by determining a required curve of the drive torque of the first drive device of the rotating cutting device, in particular of the cutting drum, for a predetermined pressure force between the cutting edges, i.e. for a specific cutting edge contact pressure force, and generating a data set from these data. Alternatively or additionally, the first contact point or, in the case of a plurality of counter-blades, the first contact points, optimized for optimum cutting are determined individually for each counter-blade and a data set is generated from these data. During operation of the cutting apparatus, the first drive device is then regulated and/or controlled according to these data sets, which allows a cutting process of the segments which is optimized for each individual gene blade.

In this case, the data set can contain various sub-data sets which define the torque and/or the torque curve and/or various alignments and arrangements of the cutting blade(s) for various predetermined pressure forces to be exerted by the cutting blade(s) on the counter-blade(s) and/or predetermined contact points of the various counter-blades. Using the provided sub-data sets, the operator can select different cutting forces to be implemented, such as 20 N or 50 N, and the first drive device is then regulated based on the torques provided in the sub-data sets to implement the cutting forces. Furthermore, the alignment and position of the cutting blade(s) can be controlled by corresponding regulation of the first drive device such that the cutting blade(s) always comes to rest at the predetermined contact point on the corresponding counter-blade at the beginning of the cutting process. The alignment and position of the cutting blade relative to the counter-blade is changed by a position regulation or of the cutting blade or control of the movement of the cutting blade, wherein the position regulation or control is realized by the regulation or control of the rotational speed and of the relative angle of rotation of the rotating cutting device to the rotary movement of the counter-rotation body.

The proposed method is further developed in that the cutting apparatus is designed according to claim 11, and the pivoting device and/or displacement device is controlled as a function of a signal from an optical sensor or pressure force sensor assigned to the cutting blade(s) and/or the counter-blade(s) and/or of the exceeding of a predetermined reaction force between the cutting blade and the counter-blade, or is controlled semi-automatically by the triggering of a control signal by the operator.

The invention is explained below using preferred embodiments with reference to the accompanying drawings, In the drawings:

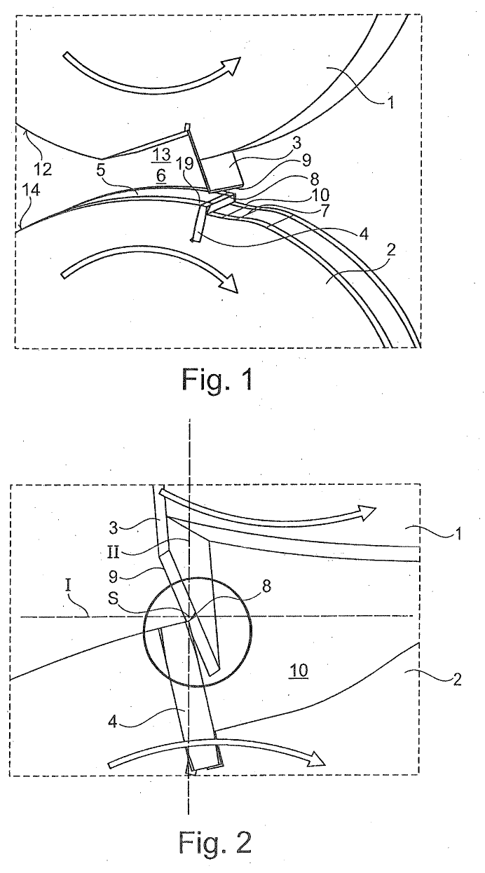

FIG. 1 shows a cutting apparatus according to the invention with a rotating cutting device in the form of a cutting drum and a counter-rotation body in the form of a counter-drum; and

FIG. 2 shows an enlarged detail of the cutting apparatus with the cutting blade and the counter-blade; and

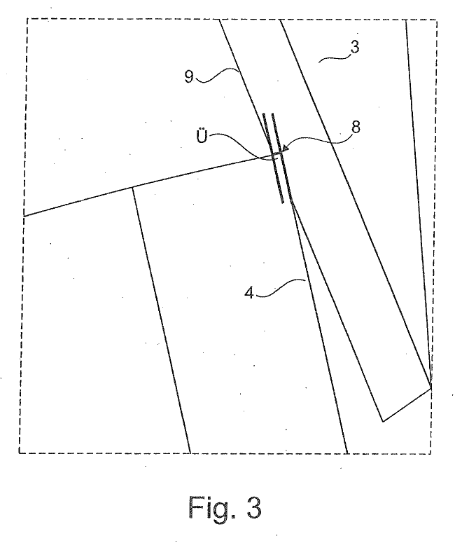

FIG. 3 shows the cutting edges of the cutting drum and the counter-drum with an overpressure in an enlarged view; and

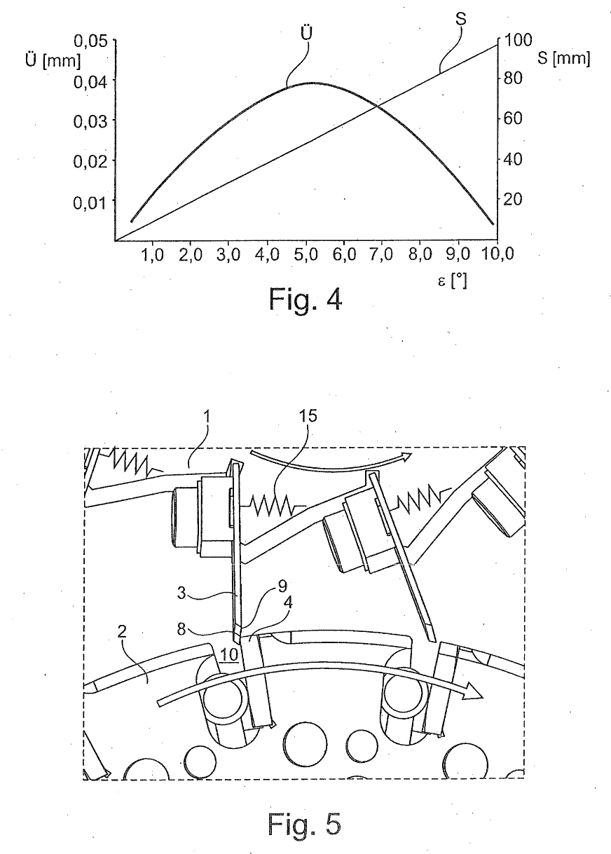

FIG. 4 shows an overpressure of the cutting edges over the angle of rotation of the counter-drum; and

FIG. 5 shows a cutting drum with a counter-drum and spring-mounted cutting blades; and

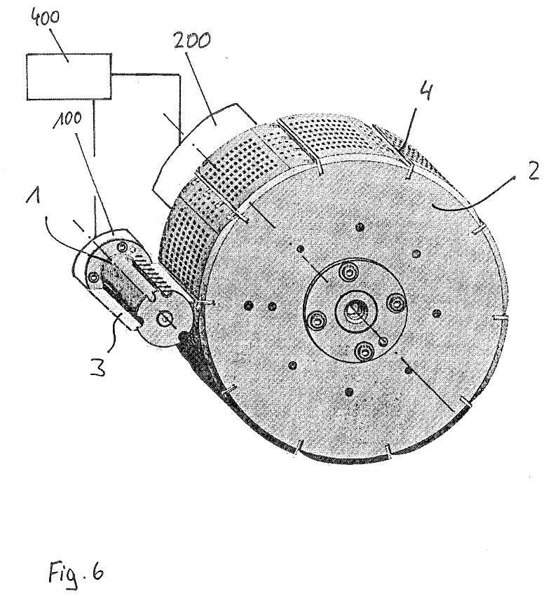

FIG. 6 shows the counter-drum and cutting drum in a perspective view; and

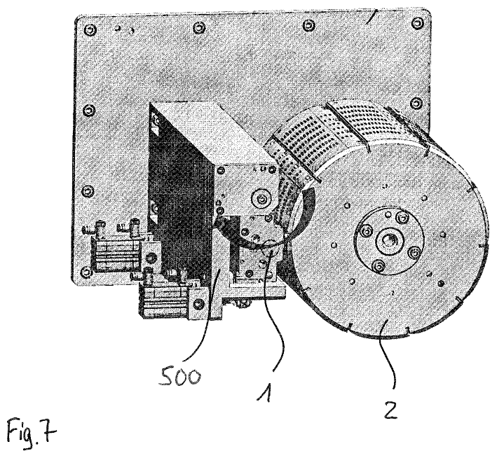

FIG. 7 shows the counter-drum and cutting drum in a perspective view on a machine frame with a pivoting device of the cutting drum;

FIG. 8 is an enlarged view of the cutting blade of the cutting drum with the counter-blade of the counter-drum in the circumferential direction; and

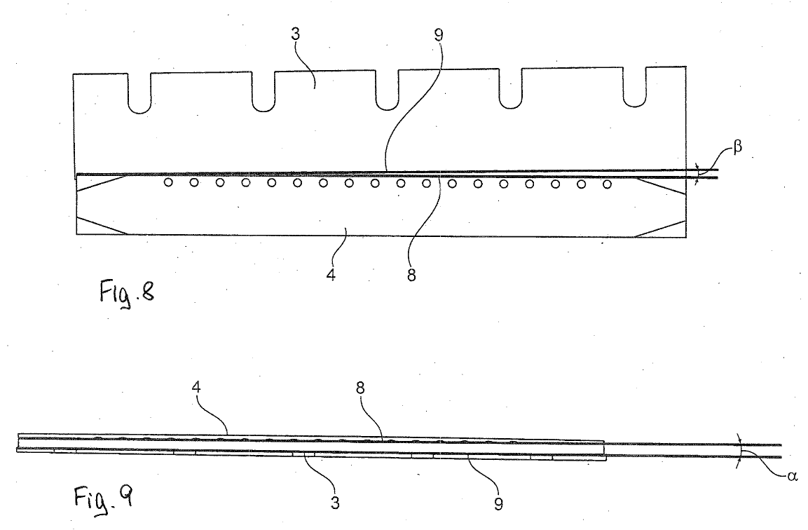

FIG. 9 is an enlarged view of the cutting blade of the cutting drum with the counter-blade of the counter-drum perpendicular to the circumferential direction.

FIGS. 1 and 2 show a cutting apparatus according to the invention with a rotating cutting device in the form of a cutting drum 1 driven counterclockwise in the direction of the arrow and a counter-rotation body in the form of a counter-drum 2 driven clockwise in the direction of the arrow. The cutting drum 1 and the counter-drum 2 are arranged such that between a jacket surface 12 of the cutting drum 1 and an jacket surface 14 of the counter-drum 2 there is a gap 6 into which a continuous web 5 of a material to be cut is fed. The continuous web 5 can be formed by a web having a cathode or anode material or having a separator material for energy cells, as described in the introduction to the description. Furthermore, the continuous web 5 can also be formed by a multi-layer composite web made of a separator material and segments of an anode or cathode material placed thereon, wherein the segments of the anode material or cathode material can be cut from a continuous web in a preceding step by an identical cutting apparatus.

The continuous web 5 rests on a contact surface 19 formed by the jacket surface 14 of the counter-drum 2 and is fed into the gap 6 by the rotary movement of the counter-drum 2. The continuous web 5 can be held on the counter-drum 2 solely by web tension or additionally or alternatively by a vacuum device.

A cutting blade 3 having a cutting edge 9 is arranged on the cutting drum 1 and protrudes radially beyond a boundary surface or outer surface 12, wherein, in relation to the direction of rotation upstream of the cutting blade 3, a recess 13 is provided in the outer surface 12 of the cutting drum 1 to form a one-sided free space on the cutting blade 3. Due to its radially protruding arrangement, the cutting blade 3 has a free cutting edge 9 on its upstream side, the distance of which from the base body of the cutting drum 1 is further increased by the recess 13.

A counter-blade 4 is provided on the counter-drum 2, which counter-blade is arranged such that its radial outer surface is arranged on an identical or almost identical radius as the jacket surface 14 or the contact surface 19. The counter-blade 4 thus forms with the jacket surface 14 and the contact surface 19 a continuous, stepless outer surface against which the continuous web 5 rests radially on the outside. Furthermore, in relation to the direction of rotation of the counter-drum 2, a recess 10 is provided in the contact surface 19 downstream of the counter-blade 4, so that the counter-blade 4 has a free cutting edge 8 on its downstream side. The counter-blade 4 can be designed as a separate part independent of the counter-drum 2 so that it can be replaced after wear or breakage. However, the counter-blade 4 can also be formed in one piece with the counter-drum 2 in that the counter-drum 2 is shaped into the cutting edge 8 on its jacket surface 14. The cutting edge 8 can also be part of an insert part of the counter-drum 2, which already has the recess 10 and can also fulfill additional functions. In other words, in addition to forming the cutting edge 8, the counter-blade 4 can also have an additional shape in order to fulfill additional functions.

“Cutting drum 1” and/or “counter-drum 2” are understood to mean all bodies which are driven in a rotary movement and to which corresponding cutting blades 3 and counter-blades 4 are fixed in the circumferential direction in order to apply the corresponding cutting edge contact pressure force during the shearing movement of the continuous web 5.

In the described exemplary embodiment, a cutting blade 3 and a counter-blade 4 are shown on the cutting drum 1 and on the counter-drum 2, but this does not exclude that a plurality of cutting blades 3 and counter-blades 4 distributed over the circumference are also provided on the cutting drum 1 and on the counter-drum 2. On the contrary, it may even be useful to provide a plurality of cutting blades 3 and counter-blades 4 evenly distributed over the circumferences of the cutting drum 1 and the counter-drum 2 if this allows more favorable cutting conditions to be achieved for the cutting of segments 7 having a predetermined length, or if the cutting frequency is to be increased at the same rotational speed. If, for example, segments 7 having a length of 100 mm are to be cut, the counter-blades 4 are then arranged such that they divide the jacket surface 14 of the counter-drum 2 into circumferential portions each having a circular arc length of 100 mm. The number of counter-blades 4 is adapted to the transport speed of the fed continuous web 5 and the rotational speed of the counter-drum 2.

The cutting drum 1 and the counter-drum 2 are driven to rotate in opposite directions so that their jacket surfaces 12 and 14 execute a movement in the same direction when passing through the gap 6, which movement corresponds to the transport direction of the fed continuous web 5 on the counter-drum 2. The cutting drum 1 and the counter-drum 2 are each driven to rotate at different circumferential speeds, so that the cutting blade 3 and the counter-blade 4 perform a relative movement to each other when passing through the gap 6. This is preferably achieved by driving the cutting drum 1 and the counter-drum 2 at identical or different rotational speeds, and by the cutting circles of the rotating cutting edges 8 and 9 having different diameters. The cutting drum 1 having the cutting edges 9 of the cutting blades 3 has a larger cutting diameter than the cutting edges 8 of the counter-blades 4 of the counter-drum 2, so that the circumferential speed of the cutting edges 9 of the cutting blades 3 is greater than the circumferential speed of the cutting edges 8 of the counter-blades 4. Due to the identical or different rotational speeds and the different diameters of the cutting circles, the cutting edges 8 and 9 meet once in each revolution given a correspondingly synchronized movement, and in doing so carry out the cutting movement of the continuous web 5 described in more detail below. Furthermore, the cutting drum 1 can, however, also have a considerably smaller diameter, and the cutting blade(s) can have a considerably smaller cutting circle diameter than the counter-drum 2 and the counter-blades 4. In this case, a plurality of counter-blades 4 are provided on the counter-drum 2, and the cutting drum 1 is driven at a considerably higher speed than the counter-drum 2.

The cutting blade 3 is arranged on the cutting drum 1 in such a way that the cutting edge 8 of the counter-blade 4, as it passes through the gap 6, comes into punctiform contact S with the cutting edge 9 of the cutting blade 3. For this purpose, the cutting edge 9 of the cutting blade 3 of the cutting drum 1 is aligned at a first angle a not equal to zero degrees, preferably at an angle a of 0 to 20 degrees in relation to the cutting edge 8 of the counter-blade 4 in a cutting plane I running through the punctiform contact S tangentially to the movement of the cutting edge 8, as can also be seen in FIG. 2 and FIG. 9. Because the cutting edges 8 and 9 yield at least slightly due to the resilient properties of the cutting blade 3 and/or the counter-blade 4, the cutting edges 8 and 9 do not lie against one another in mathematical punctiform contact S. Instead, the punctiform contact S is slightly lengthened by the flexibility of the cutting edges 8 and 9.

Furthermore, the cutting edge 9 of the cutting blade 3 is aligned with the cutting edge 8 of the counter-blade 4 such that it runs at a second angle ß not equal to zero degrees in a cutting plane II which runs through the punctiform contact S and perpendicular to the movement of the cutting edge 8, i.e. perpendicular to the cutting plane I, as can also be seen in FIG. 2 and FIG. 8.

The cutting edge 8 of the counter-blade 8 is aligned parallel to the axis of rotation of the counter-drum 4 and perpendicular to the longitudinal direction of the continuous web 5 held on the counter-drum 4 and thus also perpendicular to the circumferential movement of the jacket surface 14 of the counter-drum 4 and the feed movement of the continuous web 5.

Due to the described inclined position of the cutting edge 9 of the cutting blade 3 with respect to the cutting edge 8 of the counter-blade 4, the cutting edge 9 of the cutting blade 3 comes into punctiform contact with the cutting edge 8 of the counter-blade 4 and in doing so cuts through the continuous web 5 lying thereon. Because the cutting edge 8 of the counter-blade 4 of the counter-drum 2 is moved at a lower circumferential speed than the cutting edge 9 of the cutting blade 3 of the cutting drum 1, the punctiform contact S of the cutting edge 9 of the cutting blade 3 slides on the cutting edge 8 of the counter-blade 4 in the longitudinal direction of the cutting edge 8 of the counter-blade 4, and in doing so cuts through the continuous web 8 in a cutting line corresponding to the geometry of the cutting edge 8 of the counter-blade 4. The counter-blade 4 of the counter-drum 2 is aligned perpendicular to the longitudinal direction of the continuous web 5, so that a segment 7 having a vertical cutting edge is cut off from the continuous web 5 by the cut. The cut is made according to the shearing principle in a continuous cut transverse to the longitudinal extension of the continuous web 5, whereby a very clean and precisely shaped cut edge of the segments 7 can be realized.

The inclination of the cutting edge 9 to the cutting edge 8 in the cutting plane I in conjunction with the movement of the cutting edges 8 and 9 relative to one another, which is achieved by the different circumferential speeds, causes the cutting edge 9 of the cutting blade 3 to slide sideways in the punctiform contact S on the cutting edge 8 of the counter-blade 4. Due to the inclination of the cutting edge 9 in the cutting plane II, the sliding is also made possible by compensating for the reduction and/or increase in the distance between the cutting edge 8 and the cutting drum 1 caused by the circular movement of the cutting edge 8 of the counter-blade 4. The recess 10 provided downstream of the counter-blade 4 allows the cutting blade 3 of the cutting drum 1 to dip radially inwards through the imaginary extension of the jacket surface 14 of the counter-drum 2 during the cutting movement downstream of the counter-blade 4. This results in a vertical cut through the continuous web 5. The circular arc of the cutting movement corresponds to the angle of rotation of the counter-drum 2 starting from the first cutting contact of the continuous web 5 up to the angle of rotation of the complete cut of the continuous web 5. By dipping the cut end of the segment 7 into the recess 10, the cut edges of the cut segment 7 and of the end of the continuous web 5 still resting on the counter-blade 2 are spatially separated from one another, which makes it possible to clean the cutting surfaces in a more targeted manner by suction. In addition, cutting dust adhering to the counter-blade 4 is not stripped off at the material edge of the segment 7, and the blade cleaning of the cutting blades 3 and of the counter-blades 4 can be carried out at a maximum distance, preferably at a position of the counter-drum 2 and the cutting drum 3 rotated by 180 degrees, without contaminating the continuous web 5.

Because the two cutting edges 8 and 9 are in punctiform contact S with each other during the cutting movement, a part of the continuous web 5 is still connected across the cut line until the cut is complete. Furthermore, after the cut, the continuous web 5 rests with its free end on the outside of the counter-blade 4, which merges seamlessly into the jacket surface 14 of the counter-drum 2. This free end of the continuous web 5 then forms the second end of the subsequently cut segment 7.

In this case, the segments 7 are cut with a cutting edge 8 of the counter-blade 4 directed perpendicular to the continuous web 5 and parallel to the axis of rotation of the counter-drum 2, which is advantageous in that, firstly, a perpendicular cut through the continuous web 5 can be realized and, secondly, the continuous web 5 resting on the jacket surface 14 is not twisted about its longitudinal axis during the cutting process. However, it is also conceivable to arrange the cutting edge 8 of the counter-blade 4 at an angle to the axis of rotation of the counter-drum 2 in relation to a plane tangent to or perpendicular to the jacket surface 14, if the cut requires this or if the cut is further improved thereby.

In FIG. 9, the geometry of the cutting edges 8 and 9 can be seen in a section along the cutting plane I in the direction of view from above. The cutting edges 8 and 9 are aligned at a first angle a of approximately 2 to 5 degrees to each other and thus come into contact with each other in punctiform contact S during the subsequent circumferential movement. FIG. 8 shows the second angle ß, which here is also approximately 2 to 5 degrees. The cutting edges 8 and 9 thus first come into contact with one another on one side in the punctiform contact S shown in FIG. 2. During the further rotation of the cutting drum 1 and the counter-drum 4, the cutting edge 9 of the cutting blade 3 slides along the cutting edge 8 of the counter-blade 4 and in doing so carries out the cutting movement of the continuous web 5, wherein the changing distance between the cutting edges 8 and 9 is compensated by the second angle ß.

The rotary movements of the cutting drum 1 and the counter-drum 2 are coordinated with one another in such a way that the two cutting edges 8 and 9 come into contact with one another at a punctiform contact S during the rotation according to the curve described above and cut the continuous web 5. The cutting process necessarily requires contact, because otherwise the shearing movement can be interrupted or not carried out cleanly, which would impair the cutting quality of the segments 7. In order to ensure that this contact is not lost, the movement of the cutting drum 1 and the counter-drum 2 in conjunction with the alignment and arrangement of the blades 8 and 9 is designed such that the cutting blade 3 comes to rest on the cutting edge 8 of the counter-blade 4 with an overpressure Ü, as can be seen in FIG. 3. The cutting blade 3 thereby exerts a cutting edge contact pressure force on the counter-blade 4 and vice versa. The overpressure Ü does not, of course, lead to the counter-blade 4 penetrating with its cutting edge 8 into the cutting edge 9 of the cutting blade 3, as is shown in FIG. 3. The illustration is intended only to make the principle of overpressure Ü clearer. Instead, the cutting blade 3 and/or the counter-blade 4 are slightly pushed away taking advantage of their springy properties, which also slightly lengthens the punctiform contact S. FIG. 4 shows a curve of the overpressure Ü over the angle of rotation ε of the counter-drum 4 for a cutting width s of the continuous web of 100 mm. Furthermore, the overpressure Ü relative to the cutting width of the continuous web 5 can be seen. The angle of rotation 8=0 degrees in the diagrams corresponds to the beginning of the cutting movement. The overpressure Ü increases at the beginning of the cutting movement in a convex curve up to a maximum and then falls off steeply again.

The overpressure Ü leads to an elastic movement of the cutting blade 3 and of the counter-blade 4 and can, in extreme cases, lead to blade breakage or damage to one of the cutting edges 8 or 9 if the plastic deformation limit is exceeded locally. In order to counteract this effect, the cutting edges 8 and 9, or only one of the cutting edges 8 or 9, can be slightly concave, i.e. curved inwards, wherein the concave shape ideally corresponds to the negative shape of the measured convex overpressure Ü. Due to this concave shape of the cutting edges 8 or 9, the maximum overpressure Ü can be reduced and, in the ideal case, equalized without the contact between the cutting edges 8 and 9 being lost during the cutting process. As a result, the forces acting on the cutting edges 8 and 9 can be reduced and thus the probability of damage to the cutting blade 3 and the counter-blade 4 can be reduced. Furthermore, the breakage of the cutting blades 3 and the counter-blades 4 or their cutting edges 8 and 9 can also be avoided by using a resilient material for the cutting blades 3 and counter-blades 4, so that they can yield at least slightly.

FIG. 5 shows an embodiment of the invention in which a recess 10 is arranged on each of the counter-blades 4 upstream of the rotary movement of the counter-drum 2, so that the free cutting edge 8 of the counter-blade 4 is arranged on the upstream side of the counter-blade 4. In this case, the cutting blades 3 of the cutting drum 1 are arranged such that their free cutting edges 9 are arranged downstream of the direction of rotation of the cutting drum 1. In this case, the cutting process is carried out by driving the cutting drum 1 with the cutting blades 3 and the cutting edges 9 arranged thereon at a higher circumferential speed than the counter-blades 4 of the counter-drum 2, so that the cutting blade 3 slides with its cutting edge 9 along the cutting edge 8 of the corresponding counter-blade 4 and cuts the continuous web 5 according to the principle described above. Furthermore, the cutting blades 3 of the cutting drum 1 are spring-mounted by springs 15, so that the cutting forces acting between the cutting edges 8 and 9 are reduced by allowing the cutting blades 3 to perform an evasive movement. This allows stiffer cutting blades 3 to be used without increasing the probability of damage in the form of blade breakage. Due to the spring-loaded mounting of the cutting blades 3, the above-described overpressure Ü of the cutting edges 8 and 9 can be reduced without their contact being lost. Rather, the provided spring force of the springs 15 and their arrangement provide further design parameters for influencing the cutting process. If the cutting drum 3 and the counter-drum 4 are driven independently of each other by different drive devices, it is also possible to control the drive movement of the cutting drum 3 and the counter-drum 4 depending on the acting cutting forces.

This can prevent the exceeding of a predetermined cutting edge contact pressure force and possible resulting blade breakage. In this case, the different circumferential speeds of the cutting edges 8 and 9 are realized with identical rotational speeds and different cutting circle diameters of the cutting edges 8 and 9. If the cutting drum 1 and the counter-drum 2 are driven by different drive devices, i.e. by individual drives, it would also be conceivable to control the speed of the cutting drum 1 and the counter-drum 2 differently and individually and thereby additionally to control or bring about the relative speeds of the cutting edges 8 and 9 during the cutting process. In particular, the overpressure Ü of the cutting edges 8 and 9 can be controlled in such a way that the load on the cutting edges 8 and 9 is reduced and possible blade breakage is avoided.

FIG. 6 shows the cutting drum 1 with a first drive device 100 and the counter-drum 2 with a second drive device 200, which are each connected to a control and storage device 400 by means of a control line. The first and second drive devices 100 and 200 are each designed as servomotors which are easy to control and which drive the cutting drum 1 and the counter-drum 2 in the rotary movements shown in FIGS. 1 and 2 about their axes of rotation, which are aligned parallel to one another. The cutting drum 1 has a considerably smaller diameter than the counter-drum 2 and carries three radially outward-protruding cutting blades 3. The counter-drum 2, on the other hand, has a much larger diameter and carries a plurality of counter-blades 4, which, in the development of the arc length, have a distance from one another which corresponds to the length of the segments to be cut. Furthermore, the cutting drum 1 has a moment of inertia about its axis of rotation which is smaller by a factor of 100 than the counter-drum 2.

The cutting drum 1 is driven by the first drive device 100 to a considerably higher rotational speed about its axis of rotation than the counter-drum 2 is driven by the second drive device 200. The rotational speed of the cutting drum 1 is selected, taking into account its diameter and the number of cutting blades 3, such that a cutting blade 3 slides off the counter-blades 4 of the counter-drum 2 when passing through a defined cutting position, and in doing so cuts the continuous web 5.

The first drive device 100 of the cutting drum 1 is torque-controlled, i.e. the drive torque exerted by the first drive device 100 on the cutting drum 1 is regulable. As a result, the cutting edge contact pressure force exerted by the cutting blade 3 on the counter-blade 4 and on the continuous web 5 arranged therebetween during the cutting process can be regulated to a predetermined value. Furthermore, the cutting drum 1 can thereby be deliberately accelerated or decelerated during the rotary movements between the cutting processes, so that the cutting blades 3 come to rest on the corresponding counter-blade 4 at a predetermined contact point at the beginning of the cutting process. For this purpose, the drive torque of the first drive device 100 can preferably be controlled or regulated depending on the position or orientation of the cutting blade 3 in relation to the counter-blade 4 which subsequently comes into contact. The drive torque of the first drive device 100 driving the cutting drum 1 is thus practically controlled as a function of the angle of rotation of the counter-drum 2 due to the fixed arrangement of the counter-blades 4 on the counter-drum 2, or is regulated taking into account the signal of a rotation angle sensor assigned to the cutting drum 1. In this case, the control or regulation of the rotary movement of the cutting drum 1 is carried out in such a way that the cutting blades 4 arranged thereon are arranged in a predetermined rotational angle position and position relative to the counter-blade 4 at least during the first contact point and the subsequent cutting movement. The control or regulation of the first drive device 100 can thus also be regarded as a regulation of the position of the cutting blades 3 according to a predetermined position curve. In this case, the drive torque of the first drive device 100 is regulated while the cutting edges 8 and 9 are in contact with one another, such that the cutting edge contact pressure force corresponds to a predetermined value. For this purpose, the cutting edge 9 of the cutting drum 3 exerts a predetermined pressure force on the cutting edge 8 of the counter-blade.

Furthermore, the drive torque of the first drive device 100 can be regulated such that the overpressure Ü does not exceed a maximum value, thereby allowing a clean cut of the continuous web 5 with a reduced probability of damage to the cutting blades 3 and the counter-blades 4. The drive torque of the first drive device 100 can be further regulated such that the overpressure Ü does not fall below a minimum value, so that the cutting blades 3 do not lose contact with the counter-blades 4 during the cutting process of the continuous web 5. The overpressure Ü does not have to be measured; it can also be determined from the drive torque of the first drive device 100, taking into account the spring stiffnesses of the cutting blade 3, the counter-blade 4, and the parts involved in the force transmission path.

The rotational speed of the counter-drum 2 is preferably constant, while the regulation of the cutting edge contact pressure force, overpressure Ü, and position of the cutting blades 3 in relation to the counter-blades 4 in the first contact point and during sliding preferably takes place solely by regulating and/or controlling the drive torque of the first drive device 100. This is advantageous in that the cutting drum 1 has a significantly lower moment of inertia about its axis of rotation, preferably at least by a factor of 100, and can thus be regulated more easily, more quickly and more precisely in its rotary movement and alignment of the cutting blades 3 than the counter-drum 2 with its significantly larger outer diameter and moment of inertia. If necessary, however, the second drive device 200, i.e. the speed and/or the drive torque of the counter-drum 2, can also be regulable, so that a further manipulated variable is available for more refined regulation.

To calibrate the cutting apparatus, the cutting drum 1 is rotated until its cutting blade 3 rests against the first contact point of the counter-blade 4. For this first contact point, the exact arrangement and/or alignment of the cutting blade 3 with respect to the counter-blade 4 and/or the alignment, arrangement, and/or angle of rotation of the cutting drum 1 with respect to the counter-drum 2 in conjunction with the drive torque to be applied is recorded in a data set and stored in the storage device 400. This process is repeated for at least one last contact point of the same counter-blade 4, at which the cutting blade 3 of the cutting drum loses contact with the counter-blade 4. Thus, the angle of rotation of the cutting drum 3 and the drive torque to be applied by the first drive device 100 for the associated cutting edge contact pressure force for each of the counter-blades 4 are recorded at at least two angular rotation positions during a cutting process, namely at the first contact and at the last contact. However, it is also conceivable to regulate the cutting process with increased precision by recording the angle of rotation of the cutting drum 1 and the drive torques for the cutting edge contact pressure force for further intermediate contact points.

This process is repeated by continuing to rotate the cutting drum 1 and the counter-drum 2 exactly as in the subsequent operation until the same cutting blade 3 or the subsequent cutting blade 3 comes into contact with the subsequent counter-blade 4 for the first time.

In this way, the first contact points and the drive torques of the first drive device 100 to be realized for the corresponding cutting edge contact pressure force are measured individually for each of the counter-blades 4. From this, a data set is created for the specified cutting edge contact pressure force, indicating the angle of rotation at which the cutting drum 1 must be aligned with the counter-drum 2 for each cutting process, so that the cutting blade 3 of the cutting drum 1 comes into contact at the specified first contact point of the corresponding counter-blade 4 at the start of the cutting process. Furthermore, the data set can contain data indicating how the drive torque of the first drive device 100 and thus the angle of rotation of the cutting drum 1 and the position of the cutting blade 3 must be regulated and controlled during the cutting process so that the cutting blades 3 rest on the corresponding counter-blades 4 with the desired cutting edge contact pressure force. The data contain in particular the rotation angle positions of the cutting drum 3 and the counter-drum 4 and the changes in the relative angles of rotation for each of the counter-blades 4, wherein the changes in the relative angles of rotation can be achieved by deliberately slightly decelerating or accelerating the cutting blades 3 of the cutting drum 1 in their rotary movement by regulating the drive torque of the first drive device 100 and/or by contacting the counter-blades 4 of the counter-drum 2 with a higher or lower cutting edge contact pressure force.

Because the number of cutting blades 3 is considerably smaller than the number of counter-blades 4, they carry out a plurality of cutting processes on different counter-blades 4 during one rotation of the counter-drum 2, wherein their arrangement and/or alignment is individually regulated in relation to each counter-blade 4 by the torque regulation of the first drive device 100 during each cutting process.

The drive torque of the first drive device 100 can be regulated such that the cutting edge contact pressure force and the overpressure calculated taking into account mechanical laws do not exceed a maximum value and the overpressure does not fall below a minimum value.

To operate the cutting apparatus, the pivoting device 500 is first activated and the cutting drum 3 is moved with its cutting blades 3 so close to the counter-blades 4 that the cutting edges 9 of the cutting blades 3 are arranged in a cutting position on a defined cutting circle. The operator then sets a predetermined target value for the cutting edge contact pressure force using an appropriate input device. The corresponding sub-data set is then retrieved from the storage device 400 and, after initialization, the cutting apparatus is regulated and controlled according to this sub-data set.

After pivoting the cutting drum 1 into the cutting position, the first drive device 100 and thus the rotary movement of the cutting drum 1 are controlled according to the retrieved data set in such a way that the first cutting blade 3 comes to rest exactly at the defined first contact point of the next counter-blade 4, wherein the counter-blade 4 of the counter-drum 2 is identified based on the rotational angle position of the counter-drum 2 and then the associated first contact point of exactly this counter-blade 4 is retrieved beforehand. After the cutting blade 3 comes into contact with the counter-blade 4 for the first time, the drive torque of the first drive device 100 is regulated such that the predetermined cutting edge contact pressure force is maintained taking into account a predetermined tolerance. Because the drive torque of the first drive device 100 and the cutting edge contact pressure force are directly related, apart from the negligible bearing friction, the cutting edge contact pressure force can be regulated directly by changing the drive torque of the first drive device 100 without the need for additional pressure force sensors.

In this case, the position and/or the position curve of the cutting blades 3 relative to the individual counter-blade 4 is the target value to be achieved in the control loop, and the drive torque of the first drive device 100 is the manipulated variable in the control loop. In this case, the drive torque of the first drive device 100 can be realized, for example, by a current strength control, provided that the first drive device 100 is realized in the form of a servomotor.

Furthermore, the arrangement and/or alignment of the cutting blades 3 and/or of the cutting drum 1 can also be additionally regulated depending on the signals from the pressure force sensors and/or optical sensors or rotation angle sensors assigned to the counter-blades 4 and/or the cutting blades 3, so that wear and a change in the geometry of the cutting blades 3 and/or of the counter-blades 4 can also be taken into account. Furthermore, this allows extreme cases to be identified which require the cutting apparatus to be shut down. For this purpose, an acoustic, optical or haptic signal can be generated which is perceptible by the operator so that the operator can deactivate the cutting apparatus before serious damage occurs. Such a shutdown or deactivation of the cutting apparatus can also be carried out if a fault is detected in a higher-level device in the system and the power fails altogether.

The cutting apparatus can be deactivated very easily for this purpose in a very short period of time by activating a pivoting device 500, e.g. in the form of two pneumatic cylinders having a corresponding pivoting mechanism, and by abruptly pivoting the cutting drum 1, regardless of its angle of rotation, away from the counter-drum 4 into a passive position, so that the cutting blades 3 no longer come into contact with the counter-blades 4, or the contact is canceled. This can actively prevent a collision between the cutting blades 3 and the counter-blades 4. The same activation of the pivoting device 500 can also be carried out for maintenance of the cutting apparatus and of the higher-level system. Furthermore, the cutting drum 1 can also be pivoted away from the counter-drum 2 if the cutting process of the continuous web 5 has to be interrupted for other reasons. The cutting apparatus can preferably be deactivated automatically by pivoting the cutting drum 1 into the passive position.

1. A cutting apparatus for cutting segments for energy cells from a continuous web fed into a gap in a cutting plane, comprising:
a rotating cutting device which is driven by means of a first drive device in rotary movement about an axis of rotation, is arranged on one side of the gap and has at least one cutting blade protruding radially outwards from a boundary surface of the rotating cutting device, in particular that is a cutting drum having at least one cutting blade protruding radially outwards from a jacket surface of the cutting drum, and
at least one counter-blade arranged on the other side of the gap, wherein
the cutting blade and the counter-blade each have a cutting edge, wherein
the cutting edge of the cutting blade slides in punctiform contact on the cutting edge of the counter-blade during the-rotary movement of the cutting drum, during the cutting of the continuous web, and
the first drive device is torque-controlled at least during the sliding of the cutting edge of the cutting blade on the cutting edge of the counter-blade.

2. The cutting apparatus according to claim 1, wherein
the drive torque of the first drive device is regulated or controlled or is regulable or controllable depending on the position of the cutting blade relative to the counter-blade.

3. The cutting apparatus according to claim 2, wherein
the position of the cutting blade is controlled or regulated or is regulable or controllable by means of the first drive device depending on a position of a predetermined first contact point of the counter-blade.

4. The cutting apparatus according to claim 1, wherein
the drive torque of the first drive device is or can be regulated such that a maximum value of an overpressure (Ü) of the cutting blade relative to the counter-blade is not exceeded during the cutting.

5. The cutting apparatus according to claim 1, wherein
the drive torque of the first drive device is regulated as a function of a predetermined cutting edge contact pressure force to be exerted by the cutting blades on the counter-blade.

6. The cutting apparatus according to claim 5, wherein
the cutting edge contact pressure force is between 5 and 100 N.

7. The cutting apparatus according to claim 1, wherein
at least two counter-blades are provided, and
the drive torque of the first drive device is regulated or controlled or is regulable or controllable for each counter-blade individually depending on the position of the cutting blade in relation to the counter-blade which subsequently comes into contact therewith in punctiform contact and/or is regulated or controlled or is regulable or controllable depending on the position of a predetermined first contact point of the counter-blade which subsequently comes into contact therewith.

8. The cutting apparatus according to claim 7, wherein
a storage device is provided with a data set which represents an individualized curve of the drive torque and/or the predetermined first contact points of the counter-blades in relation to the cutting movement of the cutting blade(s) to the counter-blade(s), and
the drive torque of the first drive device is regulated or controlled or is controllable or regulable according to the torque curve of the data set.

9. The cutting apparatus according to claim 1, wherein
a warning device is provided which emits or displays a warning signal depending on an exceeding of predetermined tolerances of the alignment and/or shape of the cutting blade(s) in relation to the counter-blade(s) and/or in the event of an incorrect alignment of a counter-blade(s) and/or an exceeding of predetermined tolerances of the shape of the cutting blade(s) and/or of the counter-blade(s).

10. The cutting apparatus according to claim 1, wherein
a pivoting device or displacement device is provided with which the cutting drum can be pivoted or displaced from a cutting position into a passive position at a distance from the counter-blade(s).

11. The cutting apparatus according to claim 1, wherein
a counter-drum, is provided, and the counter-blade(s) is or are formed by one or more cutting edges arranged on the counter-drum.

12. The cutting apparatus according to claim 11, wherein
a second drive device is provided which drives the counter-drum, to a rotary movement about an axis of rotation, wherein
the axis of rotation of the counter-drum, is aligned parallel to the axis of rotation of the cutting drum, and
the direction of rotation of the rotary movement of the counter-drum, is oriented opposite to the direction of rotation of the cutting drum.

13. The cutting apparatus according to claim 12, wherein
the first and/or second drive device of the cutting drum and/or of the counter-drum, is formed by a servomotor.

14. The cutting apparatus according to claim 11, wherein
the moment of inertia of the cutting drum, is smaller by at least a factor of 100 than the moment of inertia of the counter-drum.

15. A method for controlling a cutting apparatus according to claim 11, wherein
in a calibration process, a data set of a curve of the drive torque of the first drive device and/or of the first contact point(s) of the counter-blade(s) related to the angle of rotation of the counter-drum, is generated, and
the drive torque of the first drive device is regulated or is regulable or is controlled or is controllable according to the data set.

16. The method according to claim 15, wherein
in the data set, different sub-data sets are provided which define the drive torque for different predetermined cutting edge contact pressure forces to be exerted by the cutting blade(s) on the counter-blade(s), and/or which define predetermined contact points of the different counter-blades.

17. The method according to claim 15, wherein
the exceeding of predetermined tolerances and/or the incorrect alignment is detected by an optical sensor or pressure force sensor assigned to the cutting blade(s) and/or to the counter-blade(s).

18. A method for controlling a cutting apparatus for cutting segments for energy cells from a continuous web fed into a gap in a cutting plane, wherein the cutting apparatus comprises:
a rotating cutting device which is driven by means of a first drive device in rotary movement about an axis of rotation, is arranged on one side of the gap and has at least one cutting blade protruding radially outwards from a boundary surface of the rotating cutting device that is a cutting drum having at least one cutting blade protruding radially outwards from a jacket surface of the cutting drum, and
at least one counter-blade arranged on the other side of the gap, wherein
the cutting blade and the counter-blade each have a cutting edge, wherein
the cutting edge of the cutting blade slides in punctiform contact on the cutting edge of the counter-blade during rotary movement of the cutting drum, during the cutting of the continuous web, and
the first drive device is torque-controlled at least during the sliding of the cutting edge of the cutting blade on the cutting edge of the counter-blade, and wherein
the cutting apparatus is formed according to claim 11; wherein
the pivoting device and/or displacement device is controlled as a function of a signal from an optical sensor or pressure force sensor assigned to the cutting blade(s) and/or the counter-blade(s), and/or of the exceeding of a predetermined cutting edge contact pressure force between the cutting blade and the counter-blade, and/or as a function of the operating state of a higher-level system.
